(19) United States
(12) Patent Application Publication
(10) Pub. No.: US 2011/0165919 A1
(43) Pub. Date: Jul. 7, 2011

(54) RADIOTELEPHONE MODULE AND DEVICES CONTAINING SAME

(75) Inventors: Gary Weiss, Buffalo Grove, IL (US); Jason Wojack, Libertyville, IL (US); Matt Hayek, Libertyville, IL (US)

(73) Assignee: MOTOROLA MOBILITY, INC., Libertyville, IL (US)

(21) Appl. No.: 12/899,207

(22) Filed: Oct. 6, 2010

Related U.S. Application Data
(60) Provisional application No. 61/250,219, filed on Oct. 9, 2009.

(51) Int. Cl. H04M 1/00

(52) U.S. Cl. 455/572

(57) ABSTRACT

A radiotelephone module (100) is detachably connected with another substrate (300) or structure within, for example, a handheld radiotelephone device (1100). The radiotelephone module includes radio frequency transceiver circuitry (104) and power management circuitry (108) mounted on the substrate that is coupled to a physical connection interface such as a connector (106). The power management circuitry (108) is operative to receive battery charging feedback signals (312) from off substrate battery power regulator circuitry (302), such as battery charging regulators that are located on the other substrate (300), and provide battery charging control signals (314) via the connector (106) to the off substrate battery power regulator circuitry (302). The radiotelephone module (100) may be small and detachably plugged into differing handheld radiotelephone devices that may be of differing form factors to allow a modular subassembly to be used among differing wireless radiotelephone handheld devices.

### CROSS-REFERENCE TO RELATED APPLICATION

This application claims priority to the provisional patent application having Application No. 61/250,219, filed Oct. 9, 2009, having inventors Gary Weiss et al. and owned by instant assignee, titled “RADIOTELEPHONE MODULE AND DEVICES CONTAINING SAME”.

### BACKGROUND OF THE INVENTION

The disclosure relates generally to handheld mobile devices and more particularly to handheld radiotelephones and subassemblies thereof.

Modular handheld communication devices, such as handheld radiotelephone devices in the form of cell phones, smart phones, and other devices may include a modular subassembly that plugs into a receptacle of a main housing of the handheld device. However, such removable modules typically include displays, keys and other user interface components and may be unique to a given handheld device so that it may not be compatible with other handheld devices or contain necessary functionality to accommodate other form factors or be too large for wide range use with differing wireless handheld devices that have increased functionality.

### BRIEF DESCRIPTION OF THE DRAWINGS

The present invention and the corresponding advantages and features provided thereby will be best understood and appreciated upon review of the following detailed description of the invention, taken in conjunction with the following drawings, where like numerals represent like elements, in which:

FIG. 1 is a perspective view illustrating one example of a radiotelephone module in accordance with one embodiment in the disclosure;

FIG. 2 is a perspective view of the radiotelephone module of FIG. 1 flipped over to illustrate integrated circuits on another side of a substrate of the radiotelephone module in accordance with one example set forth in the disclosure;

FIG. 3 is a block diagram illustrating one example of a combination of a radiotelephone module and another module that are connected via a connector in accordance with one embodiment of the disclosure;

FIG. 4 is a view of a connector in an unmated position in accordance with one embodiment of the disclosure;

FIG. 5 illustrates the connector of FIG. 4 in a mated configuration in accordance with one embodiment of the disclosure;

FIG. 6 is a cross sectional view of a portion of the connector shown in FIG. 5;

FIGS. 7.1-7.3 is a diagram illustrating connector pin connections in accordance with one example set forth in the disclosure;

FIG. 8 is a block diagram illustrating one example of a radiotelephone module connected with another module in accordance with one example set forth in the disclosure;

FIG. 9 is a circuit block diagram illustrating power management circuitry on both a radiotelephone module and another module in accordance with one embodiment of the disclosure;

FIG. 10 is a perspective view illustrating one example of a radiotelephone module disconnected from another module; and

FIG. 11 is a perspective view illustrating one example of a handheld radiotelephone device that employs a radiotelephone module in accordance with one example set forth in the disclosure.

### DETAILED DESCRIPTION OF THE EMBODIMENTS

Briefly, a radiotelephone module may be detachably removable with another substrate or structure within, for example, a handheld radiotelephone device via a physical connection interface. The radiotelephone module includes radio frequency transceiver circuitry and power management circuitry mounted on the substrate that is coupled to the physical connection interface, such as but not limited to a male or female connector, spring contact connector, optical connector or any suitable physical connection interface. The power management circuitry is operative to receive battery charging feedback signals from off substrate battery charging circuitry, such as battery charging regulators that are located on the other substrate, and provide battery charging control signals via the physical connection interface to the off substrate battery power regulator circuitry. The radiotelephone module may be, for example, a multi-sided integrated circuit substrate that includes not only the power management circuitry, but also baseband processing circuitry, memory, RF power amplifiers, antenna connection ports and other components so that a self contained radiotelephone module may provide data and control information for off substrate displays, cameras, speakers and other components that may be located, for example, on another substrate, also referred to as a personality board. Among other advantages, the radiotelephone module may be small and detachably removable into differing handheld radiotelephone devices that may be of differing form factors to allow a modular subassembly to be used among differing wireless radiotelephone handheld devices.

In one example, a multisided integrated circuit substrate of the radiotelephone module has a length of approximately no more than 45 mm and a width of approximately no more than 21 mm and a preferable length of 41 mm. The connector is configured with at least 180 pins and has, in one example, a square area of approximately 166 mm². In this example, a pin pitch of no more than approximately 0.4 mm is employed. The connector mates with an off substrate connector located, for example, on a personality board and may be detachably connected into the personality board and is removable by a user. The connector passes analog high frequency signals from the antenna port via the connector. The connector also passes control information from, for example, a microprocessor to an off substrate board. In addition, the multisided integrated circuit substrate may have mounted thereon radiotelephone transceiver circuitry, power management circuitry, baseband processing circuitry and radio frequency power amplifiers all operatively connected to the connector. The power management circuitry receives battery charging feedback signals from off substrate battery charging circuitry, which may, for example, be located on the personality board, and the power management circuitry also provides battery charging control signals via the connector to off substrate battery power regulator circuitry.

A kit of components is also disclosed that may include, for example, the plug in radiotelephone modular assembly (module) as set forth above along with a plurality of handheld radiotelephone devices each having a receptacle adapted to receive the plug in radiotelephone modular assembly. The plug in radiotelephone modular assembly may be operative to control either of the first and second handheld radiotelephone devices in the first and second handheld radiotelephone devices may have a different form factor, for example. In addition, the first and second handheld radiotelephone devices may also if desired have different functionality. Accordingly, a single plug in radiotelephone module may be employed in differing handsets.

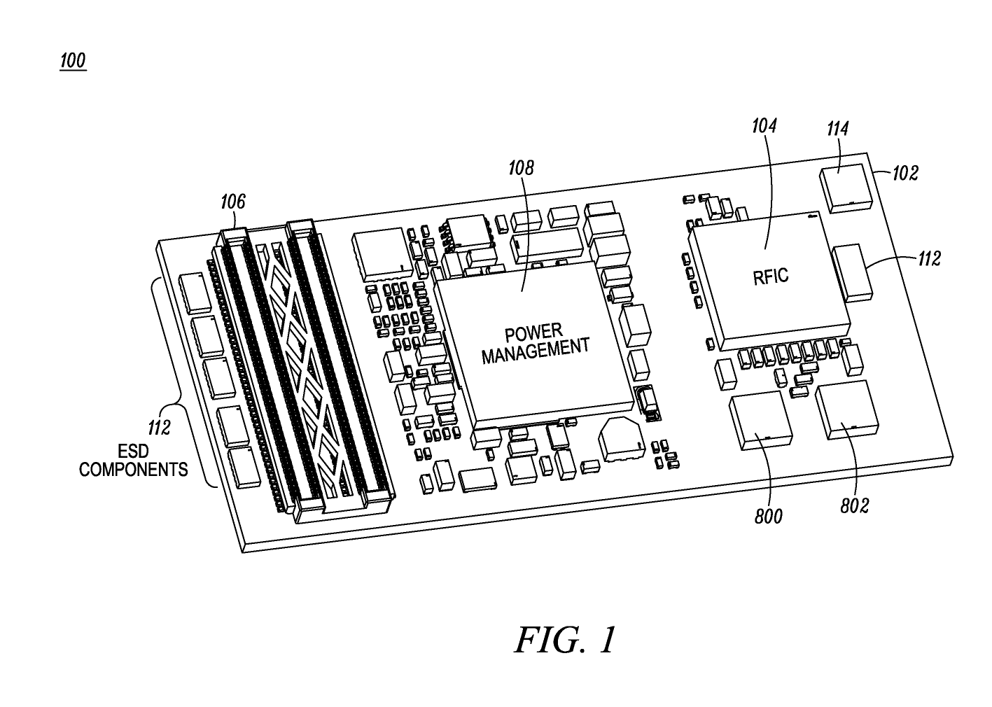

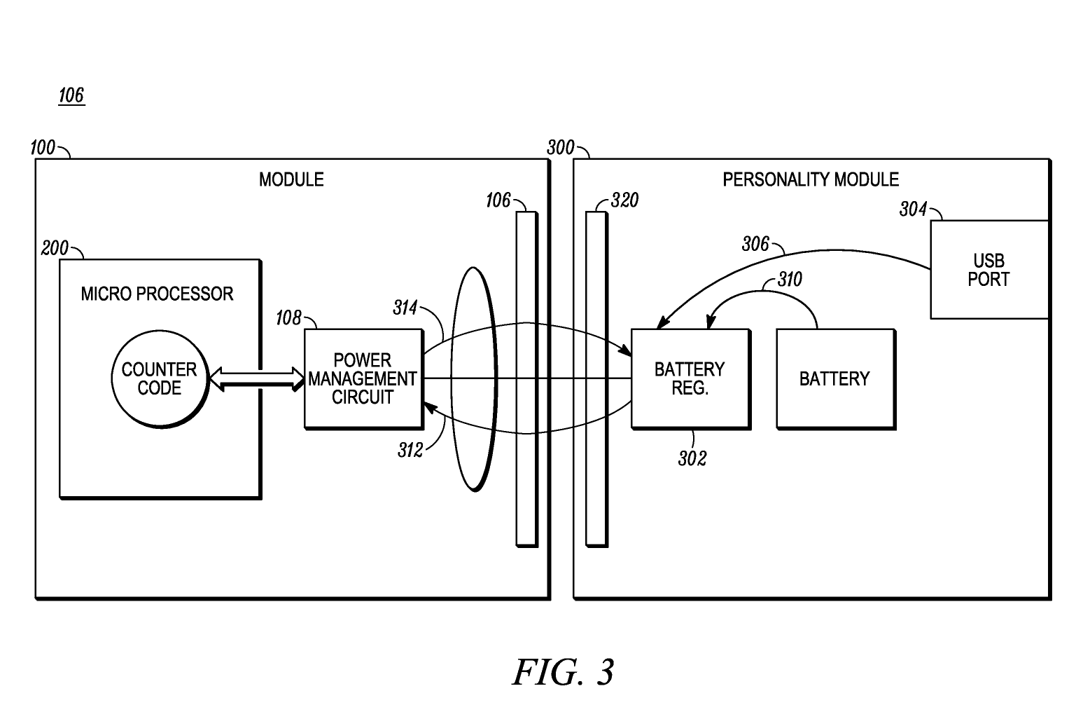

FIG. 1 illustrates one example of a bottom side of a radiotelephone module 100 that may be removably plugged in, for example, to a handheld wireless device. The radiotelephone module 100 in this example includes an integrated circuit substrate 102 such as a multi-layer printed circuit board or any other suitable substrate, that includes radio frequency transceiver circuitry 104 and a connector 106 mounted to the substrate 102. In this example, the connector 106 is configured to be detachably plugged into a corresponding connector on another substrate (see FIGS. 3-8 and 10 below). The radiotelephone transceiver circuitry 104 is connected to the connector 106. The radiotelephone transceiver circuitry 104 may be an integrated circuit chip such as a SMARTI_PMV5703 cellular transceiver chip, manufactured by Infineon Technologies AG, Germany or any other suitable circuitry. The integrated circuit substrate 102 is shown to be a multi-layer and multi-sided printed circuit board but any suitable substrate structure and material may be employed.

The radiotelephone module 100 also includes power management circuitry 108 mounted on the substrate 102 and connected to the physical connection interface shown in this example to be connector 106. The power management circuitry 108 may be, for example, an integrated circuit such as of a type referred to as TEJAS manufactured by Texas Instruments Inc., Dallas, Tex., or any other suitable power management circuitry. The power management circuitry 108 receives battery charging feedback signals from off substrate battery charging circuitry such as battery charging circuitry regulators located on another substrate, also referred to herein as a personality board (see, for example, FIGS. 3, 9 and 10). The power management circuitry 108 receives the battery charging feedback signals from off substrate battery charging circuitry via the connector 106 and provides battery charging control signals to the off substrate battery power regulator circuitry via the connector 106. The radiotelephone module 100 also includes high frequency signal traces that connect the antenna on another substrate to the radio frequency processing circuitry in the module, via the physical connection interface. The radiotelephone module 100 also includes other surface mount components as known in the art including, for example, electrostatic discharge components (ESD) 112 to protect the circuits from electrostatic damage.

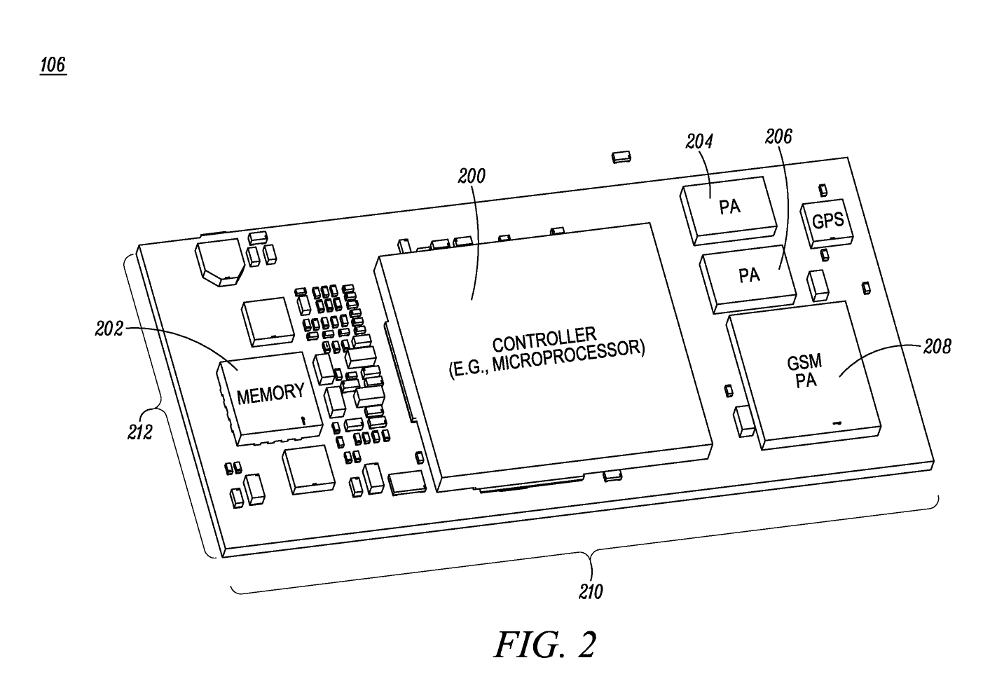

Referring also to FIG. 2, an opposing side of the radiotelephone module is shown which employs a controller 200 which may be, for example, one or more microprocessors, DSP and/or ASIC that provides the functions to control the various circuits for the desired functionality of the radiotelephone module. In this example, the controller 200 includes baseband processing circuitry and may be suitably programmed via code stored in memory 202 to perform differing functions depending upon the functionality of the wireless handheld device to which the radiotelephone module is plugged into. The radiotelephone module 100 also includes radio frequency power amplifiers 204, 206 and 208. In this example, a GSM power amplifier 208 is employed as well as other power amplifiers for other radio frequency systems. Other standard components such as filters 112 and oscillating crystal 114 are also employed as well as other conventional components.

The controller 200 is a surface mount component in this example a type referred to as HANCOCK 3G manufactured by Texas Instruments Inc., Dallas, Tex. that includes a microprocessor and DSP in one package, however, any suitable digital processing circuitry can be employed. In this example the microprocessor portion handles the modem or radiotelephone operations and the DSP handles the display, keypad and other features.

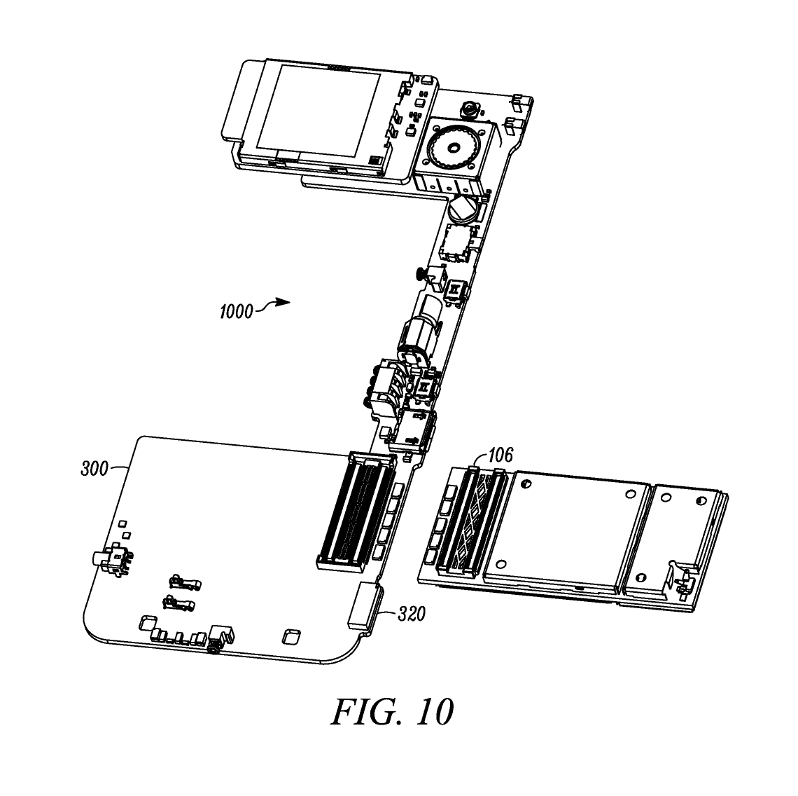

In addition, the radiotelephone module in this example uses the integrated circuit substrate that is multi-sided and has a length 210 of approximately no more than 45 mm, and preferably 41 mm, and a width of approximately no more than 21 mm. The width 212 and length 210 are given in dimensions including normal tolerance variations and are approximately 41 mm and 21 mm respectively. The connector 106 in this example has at least 180 pins and is configured to be detached to be plugged into a corresponding connector as mentioned above. The baseband processing circuitry within the controller 200 is connected to the connector 106 via pins from the controller 200. The radio frequency power amplifiers 204, 206 and 208 are also connected to the connector to amplify received signals that are received by off substrate antennas that are connected via the antenna ports 110 when the radiotelephone module is plugged into the wireless handheld device. Although not shown in the figure, suitable EMI and/or heat sinking covers may also be placed over the components in the radiotelephone module (see for example FIG. 10). The electrical traces that connect the radiotelephone transceiver circuitry 104, the power management circuitry 108, baseband processing circuitry and controller 200 and radio frequency power amplifiers 204-208 may pass and connect with the connector 106 via one or more layers within the printed circuit board or on top of the upper and lower surfaces of the circuit board as desired.

FIG. 3 is a block diagram illustrating one example of the radiotelephone module 100 and another substrate 300 also referred to as a personality based, that supports off substrate battery power regulator circuitry 302 and that, in this example, includes a port 304 to receive power from, for example, a wall plug in unit or other device. In this case, the port 304 is shown as being a universal serial bus port. However, any suitable port may be employed to provide power 306 to the off substrate battery power regulator circuitry 302. A wireless handheld device also includes a battery 308 which may be supported on the personality module or be in a separate compartment within the wireless handheld device and is shown in this example to provide feedback information 310 to the off substrate battery power regulator circuitry 302. The other substrate 300, also referred to as a personality module may connect with other components of a wireless handheld device such as a display, keypad, camera, SIM card, vibrators, accelerometers and any other desirable functionality as also described below. The controller 200 in this example is an integrated circuit that provides baseband processing, voice control processing and display control functions. However, it will be recognized that these functions can be provided in discrete logic components or may be separate integrated circuits if desired.

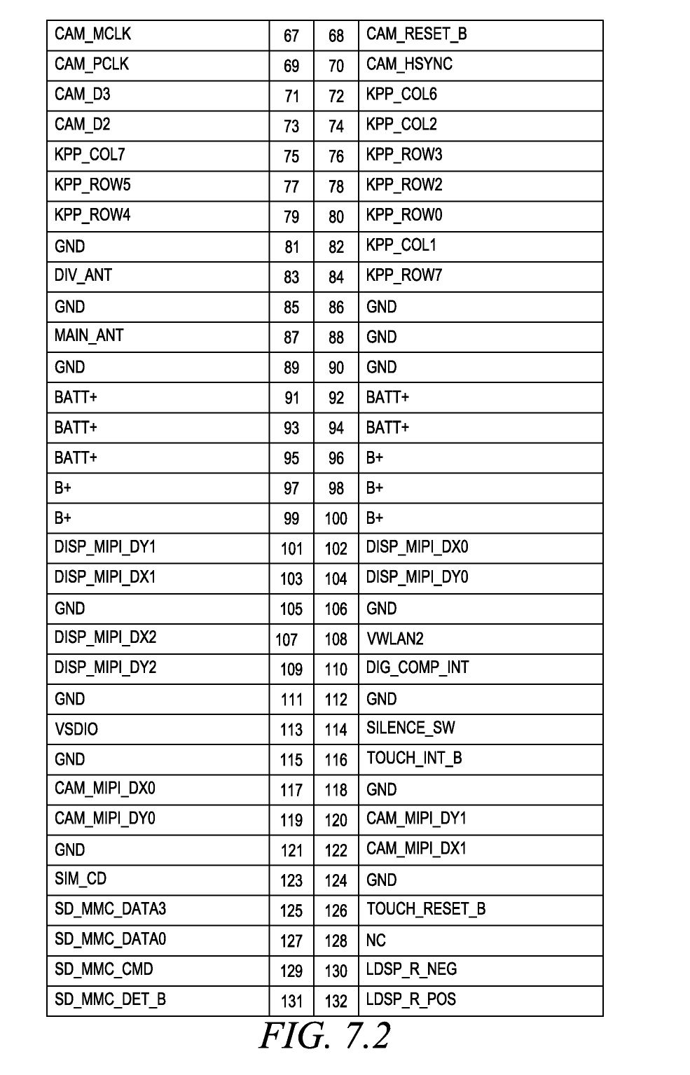

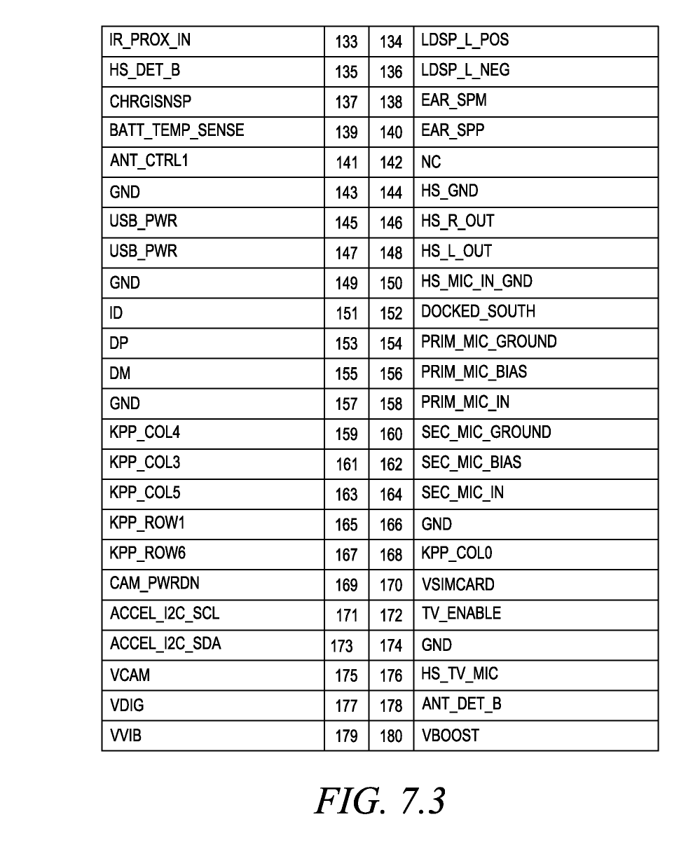

The antenna connects with the radio frequency transceiver via the connector and high frequency signal lines to pass high frequency signals through the connector 106. Examples of the high frequency signals are shown in FIGS. 7.1-7.3 below. These include for example, signals GPS ANTENNA, BLUETOOTH (BT) ANTENNA, DV ANTENNA, MAIN ANTENNA and FM RF.

The power management circuitry 108 receives battery charging feedback signals 312 from off substrate battery power regulator circuitry 302 via the connector 106. The off substrate battery power regulator circuitry 302 may include battery power regulators 302. The PMC 108 provides battery charging control signals 314 via the connector 106 to off substrate battery power regulator circuitry 302. Also, the substrate 300 includes a corresponding connector 320 that mates with connector 106.

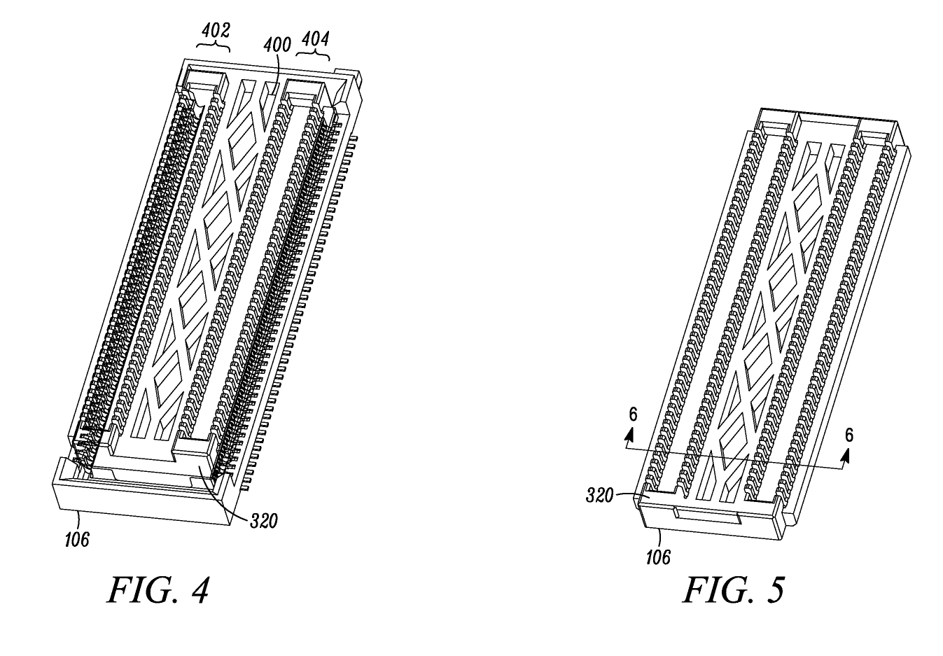

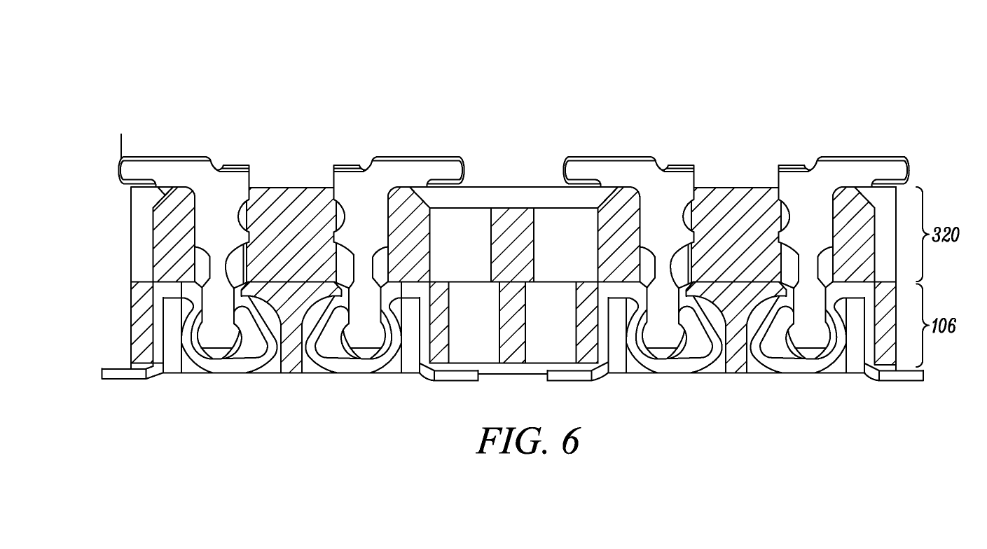

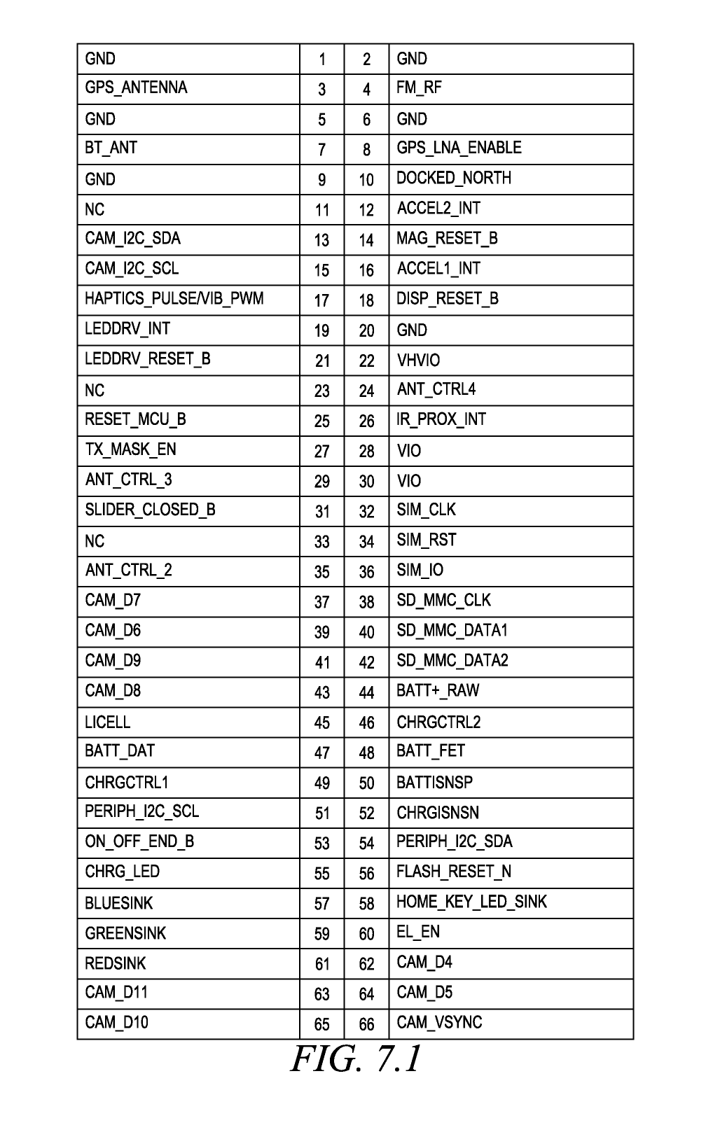

FIGS. 4, 5 and 6 illustrate one example of the connectors 106 and 320 that provide detachable plug in operation between the radiotelephone module 100 and the substrate 300. The connector 106, 320 is manufactured by Foxconn, Taipei, Taiwan as a new 180 pin connector for this embodiment that is sized to have a square area of approximately 166 mm² and a pin pitch of no more than approximately 0.4 mm (approximately includes normal manufacturing tolerances). The connector 106 mates with connector 320 as shown in cross section of FIG. 6 and the assembled view shown in FIG. 5. As seen in FIG. 1 and FIGS. 4 and 5, a ribbing structure 400 separates rows of pins generally designated as 402 and 404. When the connectors 106 and 320 mate, they have a height of approximately 2.0 mm.

FIGS. 7.1-7.3 diagrammatically illustrates the 180 pin layout of signal lines for one example of the radiotelephone module. It will be recognized however, that any suitable pinout may be utilized if desired. In this example, high frequency signals are passed through the connector (e.g. 800 MHz-3 Ghz) shown for example as signals GPS ANTENNA, BLUETOOTH (BT) ANTENNA, DV ANTENNA, MAIN ANTENNA and FM RF.

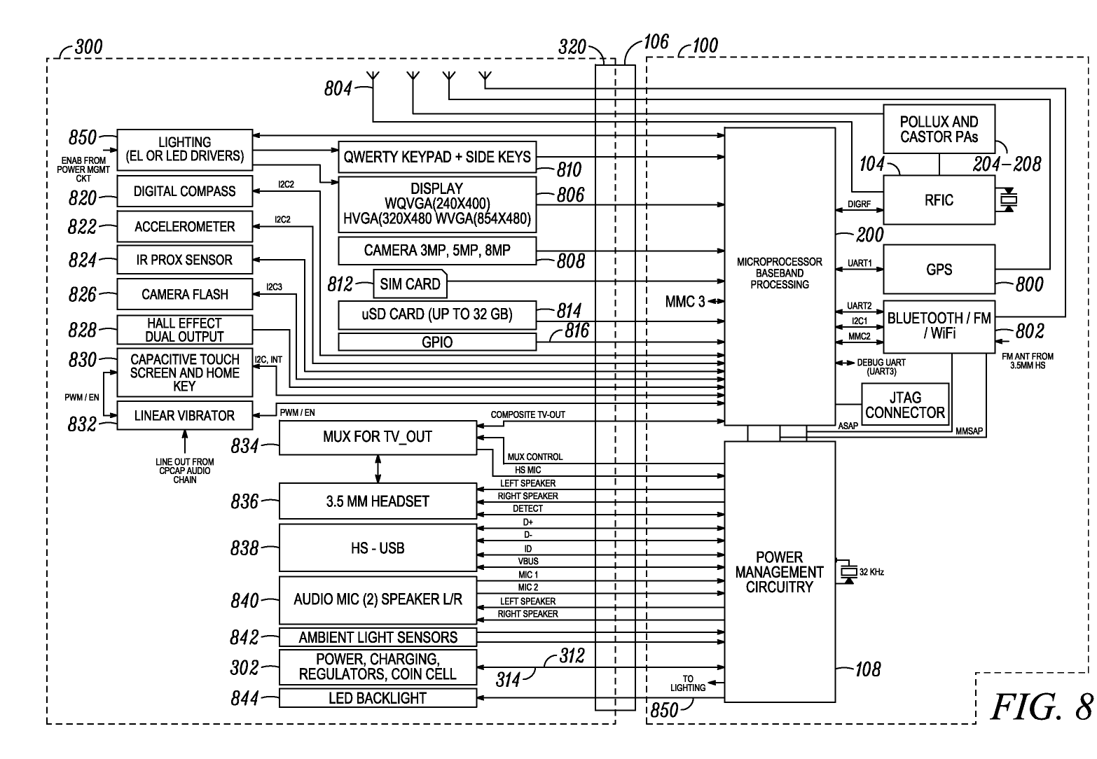

FIG. 8 is a functional block diagram of the combination of a radiotelephone module 100 and the personality board or substrate 300. The radiotelephone module 100 is shown to include other wireless functions including GPS circuitry 800, short range wireless transceiver 802, and it will be recognized that other suitable circuitry may also be employed on the radiotelephone module 100. The personality board or substrate 300 may include antennas 804 which are connected through connector 320 to connector 106, may include for example, a display 806, camera 808, keypad 810, SIM card 812, USO card 814, general purpose input/output circuitry 816, lighting for the display 818 which receives power management control signals from the power management circuit 108. The substrate 300 may also include digital compass 820, accelerometer 822, infrared proximity sensor 824, camera flash 826, hall effect output sensors 828, capacitive touch screen 830, vibrator 832, multiplexing circuitry for television output 834, headset output 836, high speed USB port 838, audio speakers 840, ambient light sensors 842 and LED or backlights 844. It will be recognized that these are just examples of functionality and fewer or more or different functions may be employed on the personality board depending upon the form function (e.g., size, contour and functionality) of the handheld wireless device in which the personality board is housed. The control and data information to and from these functionality blocks pass through the single 180 pin connector 106, 320.

The power management circuitry 108 provides off substrate display lighting control information 850 via the connector for off substrate display 806. In addition, this information may include lighting enable information for lighting block 818. Backlight LEDs 844 may be controlled with the display lighting control information.

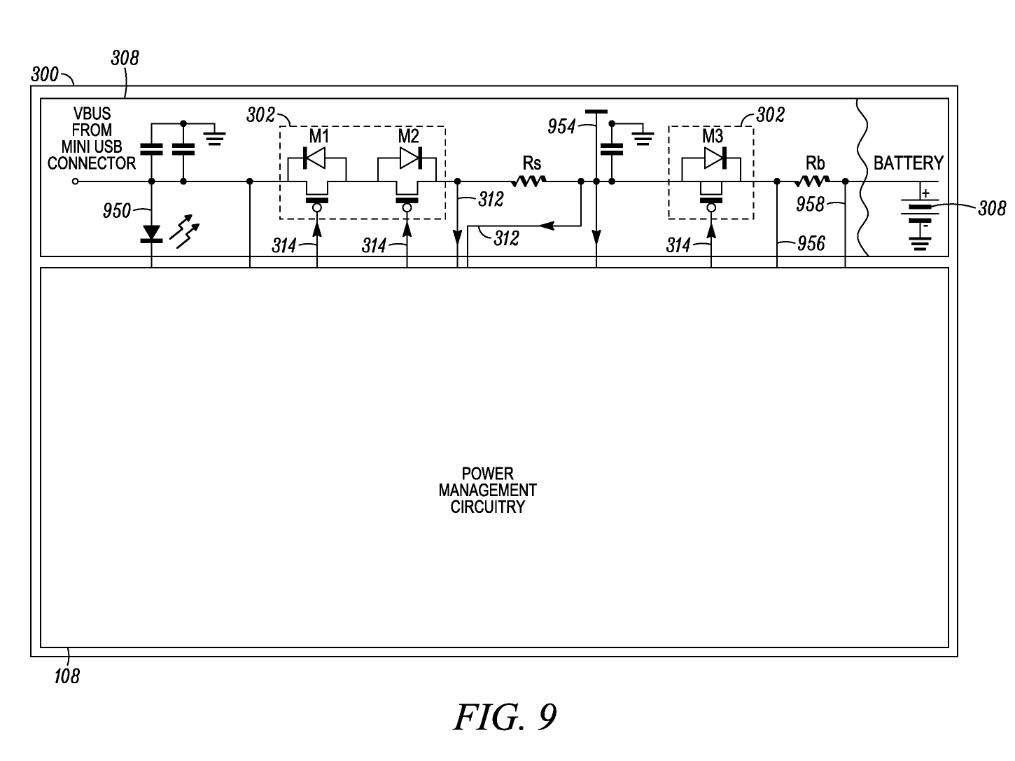

FIG. 9 illustrates a circuit block diagram of battery control circuitry and power management circuits. As shown, the substrate 300 contains off module substrate battery power regulator circuitry 302 shown as transistors M1, M2 and M3. This forms part of the substrate battery charging circuitry. Other elements may include various resistors and capacitors as known in the art. The power management circuitry 108 includes a battery voltage regulator control circuit 904, battery power voltage regulators 302, over voltage protection circuit 906, transistor control logic 908, current sample and hold circuit 910, trickle charge control circuit 912, counter 914, computer 920 and charge LED 922. The power management circuitry 108 provides control signals 314 to off substrate control the regulator circuitry to control battery charging. The power management circuitry 108 provides off substrate battery charging indication signal 950, receives off substrate charger voltage sense signal 952, a supply voltage 954 and battery current sense signals 956 and 958 and uses the information to suitably control battery charging as known in the art.

FIG. 10 illustrates an example of a substrate 300 having a cutout portion 1000 for a display. The size and configuration of the substrate 300 is based on the size or form factor of the wireless electronic device to which it is affixed.

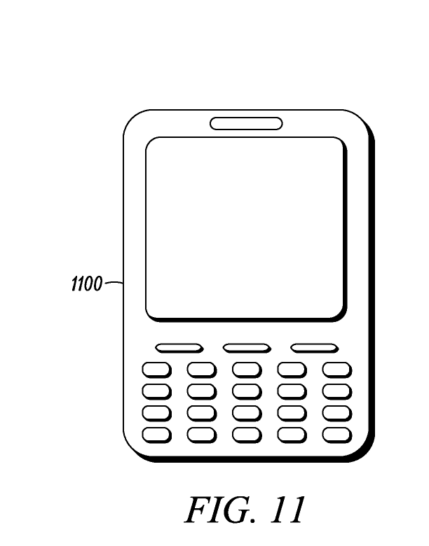

FIG. 11 illustrates one example of a handheld radiotelephone device such as a cell phone, smart phone, or any other suitable handheld device that may employ the module 106 and substrate 300. Substrate 300 may also be an integrated circuit substrate that supports integrated circuits thereon. The module 106 is detachably pluggable via outside of the housing 1100 by removal of, for example, a cover plate or may itself be a portion of a housing cover.

Among other advantages, the radiotelephone module 100 may plug into differing handheld devices having differing form factors or functionality, for example, and may serve as a type of universal radiotelephone module whose size is compatible with differing handheld devices.

The above detailed description of the invention, and the examples described therein, has been presented for the purposes of illustration and description. While the principles of the invention have been described above in connection with a specific device, it is to be clearly understood that this description is made only by way of example and not as a limitation on the scope of the invention.

What is claimed is:

1. A radiotelephone subassembly module comprising:
an integrated circuit substrate comprising radio frequency transceiver circuitry and a physical connection interface on the substrate having a connecting portion configured to be detachably removable with a corresponding connector portion on another substrate, the radiotelephone transceiver circuitry operatively connected to the physical connection interface; and
power management circuitry mounted on the substrate, operatively coupled to the physical connection interface, and operative to receive battery charging feedback signals from off substrate battery charging circuitry via the physical connection interface and to provide battery charging control signals via the physical connection interface to off substrate battery power regulator circuitry.

2. A radiotelephone subassembly module comprising:
an integrated circuit substrate comprising radio frequency transceiver circuitry and a connector mounted to the substrate, the connector configured to be detachably plugged into a corresponding connector on another substrate, the radiotelephone transceiver circuitry operatively connected to the connector; and
power management circuitry mounted on the substrate, operatively coupled to the connector, and operative to receive battery charging feedback signals from off substrate battery charging circuitry via the connector and to provide battery charging control signals via that connector to off substrate battery power regulator circuitry.

3. The radiotelephone subassembly module of claim 2 wherein the power management circuitry is operative to provide off substrate display lighting control information via the connector for an off substrate display.

4. The radiotelephone subassembly module of claim 2 wherein the substrate comprises baseband processing circuitry mounted thereon and operatively coupled to the connector; voice control circuitry mounted thereon and operatively coupled to the connector; and display control circuitry mounted thereon and operatively coupled to the connector.

5. The radiotelephone subassembly module of claim 4 wherein the substrate comprises high frequency signal lines coupled to the physical connection interface and to coupled to an antenna.

6. A radiotelephone subassembly module comprising:
an integrated circuit substrate having a length of approximately no more than 45 mm and a width of approximately no more than 21 mm comprising a connector mounted to the substrate, the connector configured with at least 180 pins and configured to be detachably plugged into a corresponding connector on another substrate, the substrate having mounted thereon at least:
radiotelephone transceiver circuitry operatively connected to the connector;
power management circuitry operatively connected to the connector;
baseband processing circuitry operatively connected to the connector; and
radio frequency power amplifiers operatively connected to the connector.

7. The subassembly module of claim 6 wherein the connector is sized to have a square area of approximately 166 mm2 and a pin pitch of no more that approximately 0.4 mm.

8. The subassembly module of claim 6 wherein the power management circuitry is operative to receive battery charging feedback signals from off substrate battery charging circuitry and to provide battery charging control signals via that connector to off substrate battery power regulator circuitry.

9. A handheld radiotelephone device comprising:
a housing containing at least:
a first integrated circuit substrate having a physical connection interface and battery power regulator circuitry thereon and operatively coupled to a display;
a detachably connected subassembly module comprising:
a second integrated circuit substrate comprising radio frequency transceiver circuitry and a corresponding physical connection interface mounted to the integrated circuit substrate, the corresponding physical connection interface configured to be detachably removed from the physical connection interface on the first substrate, the radiotelephone transceiver circuitry operatively connected to the corresponding physical connection interface; and
power management circuitry mounted on the second substrate and operative to receive battery charging feedback signals from the battery charging circuitry on the first substrate and to provide battery charging control signals to the battery power regulator circuitry via the corresponding physical connection interface.

10. The handheld radiotelephone device of claim 9 wherein the power management circuitry is operative to provide off substrate display lighting control information for the display via the connectors.

11. The handheld radiotelephone device of claim 9 wherein the second substrate comprises baseband processing circuitry mounted thereon and operatively coupled to the corresponding physical connection interface comprised of a connector; voice control circuitry mounted thereon and operatively coupled to the corresponding physical connection interface; and display control circuitry mounted thereon and operatively coupled to the corresponding physical connection interface.

12. The radiotelephone subassembly module of claim 11 wherein the second substrate comprises an antenna and having high frequency signal lines from the antenna to the physical connection interface on the first substrate.

13. A handheld radiotelephone device comprising:
a housing containing at least:
an integrated circuit substrate having a connector and battery power regulator circuitry thereon and operatively coupled to a display;
a detachably pluggable subassembly module comprising:
a multisided integrated circuit substrate having a length of approximately no more than 41 mm and a width of approximately no more than 21 mm comprising a corresponding connector mounted to the substrate, the corresponding connector configured with at least 180 pins and configured to be detachably plugged into the connector on the IC substrate, the multisided integrated circuit substrate having mounted thereon at least:
radiotelephone transceiver circuitry operatively connected to the connector;
power management circuitry operatively connected to the connector;
baseband processing circuitry operatively connected to the connector; and
radio frequency power amplifiers operatively connected to the connector.

14. The handheld radiotelephone device of claim 13 wherein the corresponding connector is sized to have a square area of approximately 166 mm2 and a pin pitch of no more that approximately 0.4 mm.

15. The handheld radiotelephone device of claim 13 wherein the power management circuitry is operative to receive battery charging feedback signals from off substrate battery charging circuitry and to provide battery charging control signals via that connector to off substrate battery power regulator circuitry.

16. A kit of components comprising:
a plug in radiotelephone modular assembly comprising:
an integrated circuit substrate comprising radio frequency transceiver circuitry and a connector mounted to the substrate, the connector configured to be detachably plugged into a corresponding connector on another substrate, the radiotelephone transceiver circuitry operatively connected to the connector; and
power management circuitry mounted on the substrate and operative to receive battery charging feedback signals from off substrate battery charging circuitry and to provide battery charging control signals via that connector to off substrate battery power regulator circuitry;
a first handheld radiotelephone device having a receptacle adapted to receive the plug in radiotelephone modular assembly; and
at least a second handheld radiotelephone device having a different form factor than the first handheld radiotelephone and also having a receptacle adapted to receive the plug in radiotelephone modular assembly wherein plugging the same plug in radiotelephone modular assembly is operational in either the first or second handheld radiotelephone device.

17. The kit of components of claim 16 wherein the substrate of the plug in radiotelephone modular assembly comprises a multisided integrated circuit substrate having a length of approximately no more than 45 mm and a width of approximately no more than 21 mm and wherein the connector mounted to the substrate is configured with at least 180 pins and configured to be detachably plugged into a corresponding connector in the first and second handheld radiotelephone devices.

18. The kit of components of claim 16 wherein the power management circuitry is operative to provide off substrate display lighting control information via the connector for either of the first or second handheld radiotelephone devices.

19. The kit of components of claim 16 wherein the substrate of the plug in radiotelephone modular assembly comprises baseband processing circuitry mounted thereon and operatively coupled to the connector; voice control circuitry mounted thereon and operatively coupled to the connector; and display control circuitry mounted thereon and operatively coupled to the connector.

20. The kit of components of claim 16 wherein the substrate of the plug in radiotelephone modular assembly comprises an antenna port supported by the substrate and having high frequency signal lines from the antenna port to the connector.

21. The kit of components of claim 16 wherein the connector is sized to have a square area of approximately 166 mm2 and a pin pitch of no more that approximately 0.4 mm.
